(19) United States
(12) Patent Application Publication
(10) Pub. No.: US 2025/0042923 A1
(43) Pub. Date: Feb. 6, 2025

(54) METHOD FOR THE PRODUCTION OF ORGANOMETALLIC COMPOUNDS

(71) Applicant: CHEMIUM SRL, Ottigines-Louvain-la-Neuve (BE)

(72) Inventors: Luc REGINSTER, Court-Saint-Etienne (BE); Bernard SIMONS, Limal (BE); Simon BOX, Tilly (BE); Marc LACROIX, Louvain la Neuve (BE); Vincent MUTTERER, Mont-Saint-Guibert (BE)

(73) Assignee: CHEMIUM SRL, Ottignies-Louvain-La-Neuve (BE)

(21) Appl. No.: 18/836,477

(22) PCT Filed: Feb. 10, 2023
(86) PCT No.: PCT/EP2023/053377

§ 371 Date: Aug. 7, 2024

(30) Foreign Application Priority Data
Feb. 10, 2022 (EP) 22156182.2

(51) Int. Cl. C07F 3/02; B01J 8/02; C07F 3/06

(52) U.S. Cl. CPC C07F 3/02; B01J 8/0242; B01J 8/0285; C07F 3/06; B01J 2208/065

(57) ABSTRACT

The current invention relates to a method for the production of at least one organometallic compound comprising: filling solid metal particulates or metal containing solid particulates into a reactor column obtaining a metal bed; continuously contacting a fluid of at least one substrate, preferably the fluid comprises a water-free solvent, with the metal bed; transporting the fluid against gravity through the metal bed, characterized in that, the fluid is partially recirculated again over the metal bed. The invention also relates to a device for the production of at least one organometallic compound, the organometallic compound itself and chemical substances produced from said compound.

### FIELD OF THE INVENTION

The present invention relates to a method for the production of organometallic compounds from solid metal or metal containing solid or a mixture thereof. In a second aspect, the present invention also relates to a device for the production of organometallic compounds. In other aspects, the present invention also relates to organometallic compounds produced according to said method or with said device. In another aspect, the present invention also relates chemical substances produced from such organometallic compound as chemical intermediate.

### BACKGROUND

Organometallic compounds are compounds having at least one carbon-metal bond (the compounds can include hydride compounds having a hydrogen-metal bond). Other elements can also be bound to the metal or carbon atom, halogens for instance. In general, the carbon-metal bond has high reactivity. Organometallic compounds are often highly flammable and some may be pyrophoric and spontaneously ignite in contact with air. The solutions are corrosive and can react violently with water. Their solvents can evaporate and may form explosive mixtures with air. The synthesis of organometallic compounds from solid metal is often characterized by very high exothermicity, hence making industrial production particularly delicate.

The organometallic compounds have become reagents indispensable to modern chemical industry. Organometallics such as organomagnesium compounds (e.g. Grignard Reagents) are commonly used due to the extreme diversity of reactions that can be performed using Grignard reagents. Among such reactions are metal interchange, alkylation for the preparation of metal alkyls, aryls and alkenyls, addition of organomagnesium compounds to C═O, C═NR and CON multiple bonds for preparing alcohols, aldehydes, ketones carboxylic acids, esters and amines. The Grignard reaction is also a frequently applied method for coupling C—C bonds. Compounds containing one or several aluminium-carbon bonds are also of significant importance for the industry, resulting in large volume, high value organoaluminium production. Compounds such as trialkylaluminium compounds or alkylaluminium sesquichloride are industrially important organoaluminium compounds used primarily as catalyst component in Ziegler-Natta type systems for olefin polymerizations.

Organozinc compounds are compounds containing at least one zinc-carbon bond. Although they are less reactive than other organometallic compounds, they are used as reagents in reactions of industrial importance such as the Reformatski reaction or the Negishi cross-coupling.

Organolithium compounds are also of industrial importance and are often used for deprotonation or carbon chain transfer through a nucleophilic addition. Organolithium compounds are used industrially in polymerisation initiation for synthetic elastomers but also in synthesis of pharmaceutical ingredients. Methyllithium, n-butyllithium, n-hexyllithium and phenyllithium are important organolithium compounds.

The above-mentioned organometallic compounds are preferably prepared by the reaction of a substrate as defined below such as organohalide, defined as compounds containing a carbon-halogen bond, organometallic salts, possibly in the presence of activating components, with the relevant solid metal or metal containing solid. Most of such reactions are characterized by the necessity to activate the metal solid and most notably by a high exothermicity, hence resulting in significant risk of runaway if the process heat management happens to be unsufficiently effective.

The present invention relates to a continuous method and a device to prepare organometallic compounds from solid metal or metal containing solid, such as metal-halides, such method allowing the adequate management of high exothermicity regardless of the scale of the reactor.

Table 1 provides for some examples of organometallic compounds of industrial importance that can be produced from solid metal or metal containing solid. The table also provides for the nature of metal, the substrates, as defined below, reacting with such metal and solvent when applicable.

TABLE 1
Examples of organometallic compounds produced from solid metal particulates

| | Organometallic | Metal | | | | |
|---|---|---|---|---|---|---|
| # | Compound | Particulate | Substrate | Solvent | Application | Sources |
| 1 | (4- | Mg | bromo-4- | THF | Active | WO 2014/ |
| | (dimethoxymethyl) | | (dimethoxymethyl) | | Pharmaceutical | 207206 A1 |
| | phenyl) | | benzene | | Ingredient | |
| | magnesium | | | | (Valsartan) | |
| | bromide | | | | | |
| 2 | Vinyl Magnesium | Mg | Vinyl Chloride | THF | Vitamin A (ref) | |
| | Chloride | | | | | |
| | (4-chlorophenyl) | Mg | p-dichlorobenzene | THF/Toluene | Agrochemical | EP 0545099 |
| | magnesium | | | | (Boscalid) | CN 110054642 A |
| | bromide | | | | | |
| 3 | Methylaluminium | Al | Methyl Chloride | — | Catalysts, | U.S. Pat. No. |
| | sesquichloride | | | | plasticizers | 3,028,408 A |
| 4 | (2-methyl-2- | Zn | 1-(2-iodo-1,1- | THF | Pharmaceutical | U.S. Pat. No. |
| | phenylpropyl) | | dimethylethyl) | | APIs | 6,184,404 B1 |
| | zinc(II) iodide | | benzene | | | |
| 5 | lithium bis(2- | Li | ethyl bis (2-anisyl)- | Dioxane | Catalysts | U.S. Pat. No. |
| | methoxyphenyl) | | phosphinite | | synthesis for | 7,067,701 B2 |
| | phosphanide | | | | polymerization | |
| 6 | 2-thiazolyl zinc | ZnCl2 | 2-thiazolyl | THF/Toluene | Pharmaceutical | U.S. Pat. No. |
| | bromide | | magnesium | | APIs | 6,448,408 B1 |
| | | | bromide | | | |

Operational and reaction technology for preparation of organometallic compounds from solid metal have remained largely unchanged over the last 100 years. Usually, the reaction is carried out in a batch process, i.e., a batch or fed-batch process in which metal solid or metal containing solid are progressively put in contact with a substrate, as defined below, either pure or contained in a solvent. However, a major disadvantage of such batch approach results from the long induction phase needed to activate the metal, such as magnesium, zinc or aluminium and the resulting difficulty to manage the high exothermicity of the reaction.

Direct metal insertion in an organohalide substrate for the production of organometallic compounds is highly exothermic. Therefore, care should be taken to ensure that the reaction does not run-away. For this reason, the induction phase is performed in a very progressive, therefore very slow approach. Different strategies can be used for activating the metal, such as addition of iodine or addition of a quantity of the previously produced organometallic compound. In any case, a small quantity of the organohalide is added to ensure the reaction initiates. Once reaction has initiated, the addition of organohalide is maintained at a suitable rate to ensure the reaction is maintained and controlled until all the organohalide is consumed. The supernatant organometallic solution is removed from the reaction mixture by filtration. Such method appears to be cumbersome and bears significant risks of run-away of the reaction.

Given above mentioned difficulties in managing high exothermicity in large batch reactors, numerous attempts have been made to produce organometallic compounds from metal solid in continuous process. DE1293767 discloses a process wherein Mg particles are contacted with at least one organohalide by feeding organohalide dissolved in cyclic ether to the bottom of a column that is filled with—and replenished from the top with—Mg turnings. In U.S. Pat. No. 2,464,685 a continuous process for effecting reaction between Mg and organohalide is described, wherein the organohalide in ether solution is supplied to a body of Mg particles under continuous agitation. WO2021056193A1 describes a process in which zinc powder is reacted with carbon-halide in a continuous reactor comprising a heating section and a cooling section. U.S. Pat. No. 4,105,703 describes a continuous Grignard process wherein cyclohexyl halide solution is fed to the bottom of a column-like reactor packed with magnesium shavings, which are fed from the top of the column. In US391 1037 Grignard reagent is made continuously by feeding organohalide and solvent to at least one stirred reaction vessel, while concurrently feeding Mg and withdrawing product overflow. Drawbacks of such processes using e.g. stirred bed or packed column reactors include non-optimal heat and mass transfer during highly exothermic reaction. A further difficulty lying in the relatively slow conversion also limiting the throughput achievable in a continuous process.

A process to achieve activation and enhance the conversion rate in continuous process by mechanical friction is described in WO 2017 178 230. Two streams are mixed inside the reactor. One stream consisting of an alkyl or aryl halide and an anhydrous solvent and another stream consisting of magnesium particulates. The magnesium particulates are activated by vibrations at a frequency of 20 to 200 Hz.

WO 2014 207 206 relates to a process of preparing a Grignard reagent comprising reacting magnesium powder in a fluidized bed reactor. The continuous process comprises a solvent flowing against gravity through a bed of magnesium particulates with a flow rate ranging from 0.1 to 0.3 cm/s to create a fluidized bed of magnesium particulates in the solvent. The fluidization requires powder particles comprised between 10 and 1000 microns.

CN111718279 discloses a method and a device for continuously producing sartanbiphenyl. CN212595730 discloses a fixed bed reactor for Grignard reactions. WO2002020151 discloses a method of performing a chemical reaction between a material in particulate form and a liquid that comprises the reagent.

WO2014207206 discloses a continuous process comprising fluidizing magnesium particulates in a reactor, forming the Grignard reagent. U.S. Pat. No. 3,285,968 provides a process for producing calcium alkoxy alcoholates by reacting calcium carbide with a glycol ether. GB809310 discloses a reactor divided by means of screening plates with perforations. U.S. Pat. No. 3,911,037 describes a continuous Grignard reactor wherein an excess of magnesium is constantly maintained.

When the liquid inside the reactor flows from top to bottom, the solids inside the reactor are more likely to cause clogging issues. Furthermore, filters are more likely to clog rapidly.

Scale-up for industrial production under these methods remains however intrinsically limited by the heat removal limitation resulting from unfavourable surface to volume ratio or by the use of metallic powder which is known to create safety hazards.

Starting from the known prior art, it is an object of the present invention to provide a continuous method for producing organometallic compounds from solid metal or metal containing solid which provides at the same time the following benefits over methods described in the prior-art:
improved mass transfer, hence allowing faster reaction and higher conversion, improved heat transfer, resulting in optimum temperature control,
high heat removal capacity resulting in significant process safety improvement,
use of metal in a non-powder form, hence reducing significantly safety risks, straightforward scalability,
significant reduction of procedural steps

### SUMMARY OF THE INVENTION

The present invention and embodiments thereof serve to provide a solution to one or more of above-mentioned disadvantages. To this end, the present invention relates to a method for the production of at least one organometallic compound according to claim 1.

A continuous process including a thermally controlled recirculating loop provides a very effective way to remove heat from the reactor regardless of its size or aspect ratio. Furthermore, for a given injection throughput of substrate, the recirculation flow, which can be adapted to particular circumstances, allows to increase the turbulence and flow movements within the bed of metal particulates, which then tends to act as a static mixer. Such turbulence and flow movements provide not only the benefit of enhancing significantly the heat transfer within the reactor, but also the benefit of a higher and faster mass transfer, hence increasing significantly the kinetics of the reaction. The result is a more productive, safer, more flexible and scaleable process compared to batch process or even to a continuous process where thermal control is performed through the walls of the reactor.

Preferred embodiments of the method relate to the handling of solid particulates within a continuous process and are shown in any of the claims 3 to 6. A specific preferred embodiment relates to an invention according to claim 3.

In a second aspect, the present invention relates to a device according to claim 10. More particular, the device as described herein provides a well-controlled environment to conduct reactions between solid metals and/or metal containing solids and substrates as defined below.

In a final aspect, the present invention relates to a compound produced according to the method and/or with the device according to the previous aspects. It also relates to a chemical substance produced from such organometallic compound as chemical intermediate.

### FIGURE TITLES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a schematic representation of an embodiment of the present invention.

FIG. 2 shows an injection bottom according to an embodiment of the present invention.

### DEFINITIONS

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

An “organometallic compound” is a compound containing as least one carbon-metal bound, for example with the formula R-M, R-M-R, M-R, R-M-X or M(-R)ₘ(—X)ₙ(-Het)ₒ, whereby the R represents an organic compound, X a halogen atom, Het any heteroatom-based functionality and M a metal. Examples of metals are Mg, Li, Na, Al, Fe, Si, Zn, Cu, Ru, Al, Sn, Ca. Examples of halogens are F, Cl, Br or I. All known alkyl, alkenyl, alkynyl, allyl, aryl and heteroaryl groups can be used as organic compounds. Furthermore, preferred are alkyl groups with 1 to 20 C atoms, alkonyl and alkynyl groups with 2 to 20 C atoms and allyl groups with 3 to 20 C atoms. The alkyl, alkenyl, alkynyl and allyl groups can be either linear or branched. Furthermore, one or more CH₂ groups in the alkyl, alkenyl, alkynyl and allyl groups can each be replaced independently of one another by —O—, —S— or —NRR′— so that heteroatoms are not directly linked to one another. Preferred aryl or heteroaryl groups contain one or more aromatic or heteroaromatic rings, which may optionally be substituted. Preferred substituents are halogen, linear or branched, optionally chiral, unsubstituted, mono- or poly-substituted alkyl groups having 1 to 10 carbon atoms or alkenyl or alkynyl groups having 2 to 10 carbon atoms, in which one or more CH₂ groups can each be replaced independently of one another by —O— or —S— in such a way that heteroatoms are not linked directly to one another. Heteroatom-based functionalities can be hydrides or any organic functional groups wherein oxygen, nitrogen, phosphorous, arsenic or sulfur atoms are directly bonded to M. In the following text, R—X, i.e. organohalide, will be referred to as the substrate.

An “organohalide” is a compound containing at least one carbon-halogen bond. Examples of halogens are F, Cl, Br or I.

A “substrate” is a compound involved in a chemical reaction with at least one other reactant or reagent. Accordingly, organohalides as defined above, metal salts, organometallic compounds, molecular hydrogen, unsaturated organic compounds, such as olefins or alkynes or carbonyl compounds, . . . , can be referred to as substrate in the context of a reaction with solid metal particulates and/or with metal containing solids. Furthermore, organohalides as defined above, metal salts, organometallic halides, organometallic complexes, aldehydes, ketones, imines, activated carboxylic acids, acylhalides and any carbonyl compound, nitriles, carbon dioxide, oxygen, sulfur, transition metal-based complexes and catalysts, whether supported or not, silanes and there derivatives, boranes and their derivatives, phosphines and their derivatives or any other compatible electrophilic compound, or acidic compounds, as alcohols, amines, amides or acidic hydrocarbons, known to the persons skilled in the art can be referred to as a substrate in the context of a reaction involving an organometallic compound, as defined above, prepared according to the present invention.

### DETAILED DESCRIPTION OF THE INVENTION

The invention relates to a method for the production of at least one organometallic compound.

In a first aspect, the invention relates to a method for the production of at least one organometallic compound comprising: filling solid metal particulates or metal containing solid particulates into a reactor column obtaining a metal bed; continuously contacting a fluid of at least one substrate, preferably the fluid comprises a water-free solvent, with the metal bed; transporting the fluid against gravity through the metal bed, characterized in that, the fluid is partially recirculated again over the metal bed.

In a preferred embodiment, the fluid is composed of a substrate and a water-free solvent. In another embodiment, the fluid is only composed of one or more substrates.

In an embodiment, recirculating the fluid comprises pumping the fluid through a heat exchanger. In a further embodiment, a pump is present in this recirculating loop, suitable to pump the fluid through at a suitable flow rate.

Suitable recirculation flow rate optimization is described later below.

The advantages of the recirculation loop are dual. Firstly, the reaction being exothermic, managing the heat generated by the chemical transformation is a critical part of the process. The management of the heat, the distribution of the calories in the reactor and the stabilization of the temperature in the reactor are ensured by a recirculation loop. At the top of the reaction column, part of the fluids are pumped out of the reactor, filtered and cooled before being sent back to the bottom of the reactor. The recirculation flow and the temperature regulation of the loop are critical to regulate and homogenise the reaction temperature in the reactor. Secondly, the present reactions being mass transfer dependent reactions, the high flow of fluids and the turbulences in the reactor are improving the kinetics of the reaction. On top of that, it is expected that better heat and mass transfers control are beneficial for the efficiency of the reaction.

Yet, in spite of the previous statements, obvious for the skilled persons, it has surprisingly been observed that too high recirculation rate may be deleterious for the process, and such recirculation rate and ratio need to be optimized as described later.

It is further observed that the accurate temperature regulation results in a reduction of side reaction and resulting by-products.

In an embodiment, the fluid is partially recirculated again through a heat exchanger and over the metal bed at a recirculation ratio, wherein the recirculation ratio is the ratio between the mass flow rate through the metal bed and the mass flow rate of substrate entering the reactor and wherein the recirculation ratio is used to optimize the production of at least one organometallic compound. The production of at least one organometallic compound is optimized by using the reaction conditions.

The highly efficient temperature regulation resulting from the recirculation loop, combined with an adequate pressure and temperature instrumentation, and the possibility to stop instantly the addition of the reacting substrate, described in the present invention is a safer alternative, compared to common batch process, to produce organometallic compounds in a continuous mode. In yet another embodiment, the present invention relates to minimizing hot spot formation, a problem frequently encountered in packed beds or when using metal turnings, and which has been overcome by the turbulences resulting from the use of a recirculation loop.

In some embodiments, filters and purges can be used in the loop circuit in order to remove solid impurities or products from the system that would otherwise accumulate within the reactor.

In some embodiments, a recirculation pump is installed to generate the flow through the recirculation loop. For this purpose, a centrifugal pump is a good option as the recirculation flows are quite large while the pressure drop in the recirculation loop is relatively small. In a further embodiment, the recirculation relates to higher bed-to-surface heat transfer. In yet another embodiment, nearly uniform temperatures are maintained under highly exothermic reaction conditions, which is very difficult or not feasible when using a conventional packed bed without recirculation loop. Where DT represents the difference between highest and lowest temperature measured from 5 probes within the reactor, an experiment shows DT=62C when no recirculation is applied, DT=41C when recirculation ratio of 1:1 is applied and DT=6C when recirculation ratio of 10:1 is applied.

In another embodiment, surprisingly, on top of heat exchange efficiency, particle entrainment and chemical reaction selectivity must be considered when optimizing recirculation rates and ratios, as later described.

In an embodiment, before being sent back in the reactor, the liquid is passing through a heat exchanger. In a traditional column reactor, the flow has to be maintained at low ascending speed so as to allow sufficient residence time to complete the reaction. Increasing throughput by increasing column diameter is limited by low heat transfer within the reactor (slow flow environment), and by the heat exchange surface available (increasing by square of reactor diameter whilst heat generation increases to the cube of reactor diameter). The use of a recirculation loop equipped with heat exchangers allows firstly for a more turbulent flow within the reactor, whilst maintaining the average residence time and secondly for heat removal capacity that can be adjusted independently from the diameter of the reactor. As expected by the skilled person, several types of heat exchangers and cooling liquids can be used, hence allowing massive heat removal capacity independently from the overall throughput of the process. The reaction temperature can be accurately maintained at the desired setting, depending on the organometallic compound to be produced. In one embodiment, the reactor temperature is maintained at temperatures in the range of about 10 C to about 150 C, or from about 75 C to about 125 C. In another embodiment, the temperature is maintained at about 40 C. In yet another embodiment, the temperature is maintained in the range of about-20 C to about 50 C. For slow reaction, the reaction rate is increased by increasing the temperature of the reactor under pressure.

The pressures before and after the heat exchangers are measured to monitor any fouling that might occur in the small internal tubes.

The preferred residence time of the substrate within the bed of metal particulates will depend on the particular substrate, other solvents if any, and the temperature. A skilled person of the art will know how to vary the flow conditions, temperature and residence time based on specific reactants to optimize reaction conditions.

In an embodiment, the reactor head was designed in order to prevent solid metal particles to be sucked into the recirculation loop and/or into the reactor outlet, by lowering the accessional speed of the liquid, hence casing sedimentation of the metal particles. In an embodiment, the reactor head is shaped in such a way that metal particulates are optimally retained within the reactor body, preferably the reactor head has a conical shape. In an embodiment, the settling zone has a cross section surface at least 100% bigger compared to the cross section surface of the reactor column, preferably 400% bigger. The head has been designed so that the liquid reaching the top has an ascending speed low enough to prevent most metal parts to be carried away through the reactor outlet. This reduces contamination, clogging and improves the process control.

In an embodiment, an optimal recirculation rate has to be determined. As described above, high recirculation rate allows highly efficient thermal regulation of the process. Therefor, maximal recirculation rate would be recommended by the skilled person. Surprisingly, however, it was found that too high recirculation rates are deleterious for the process since the associated vertical speeds through the metal bed tend to fluidize the metal particles sooner than it could be expected based on the particle size distribution of the fed metal. This precoce particle entrainment finally causes plugs and process interruption.

In an embodiment, an experiment shows that recirculation rates, i.e. the absolute flow velocity through the metal bed, below 2 m/h result in poor thermal regulation leading to by-product formation and eventually to process interruption, while rates above 40 m/h result in risk of reactor plugging and process shutdown. In an embodiment, recommended recirculation rates range between 3-25 m/h, preferably 8-20 m/h, most preferably 12-16 m/h.

In yet another embodiment, an optimal recirculation ratio, i.e. the ratio between the mass flow rate through the metal bed and the mass flow rate of injection, has to be determined. High recirculation rates allow highly efficient mass transfer. Therefor high ratios would be recommended by the skilled person to favor the mass transfer of the process. Yet, surprisingly again, it was observed that too high recirculation ratios may negatively affect reaction selectivity yielding fewer desired product. In an example, under steady flowrate conditions for a given class of Grignard reagent, recirculation ratios of 4 or 6 both yielded <94% Grignard reagent, while a recirculation ratio of 5 afforded >97% yield.

| Recirculation ratio | 4 | 5 | 6 |
|---|---|---|---|
| Conversion | Moderate | Optimal | Good |
| Yield | Moderate | Optimal | Moderate |
| Selectivity | Good | Optimal | Moderate |

In the prior art however, thorough recirculation ratio optimization is never carried out and high ratios are advised to maximize heat exchange without considering the above mentioned deleterious effects on particle entrainment and reaction yield.

In an embodiment, the recirculation ratio is between 10:1 and 1:1. In an embodiment, the recirculation ratio is between 25:1 and 42:1. In an embodiment, the recirculation ratio is between 15:1 and 25:1. In an embodiment, the recirculation ratio is between 15:1 and 20:1. In an embodiment, the recirculation ratio is between 15:1 and 25:1. In an embodiment, the recirculation ratio is between 3:1 and 7:1. In an embodiment, the recirculation ratio is between 40:1 and 70:1. In an embodiment, the recirculation ratio is between 10:1 and 70:1.

In an embodiment, the reaction is initiated by the addition of an activator such as iodine or an organometallic compound. It is a benefit of the continuous process that such activator can be easily separated from the produced organometallic compound by simply discarding the first quantities produced. Once the initiation has started, addition of initiator can be stopped as the organometallic compound is constantly recirculated over the metal bed through the loop.

In an embodiment, part of the liquid is extracted from the reactor at a certain level and recycled at the same level or to a lower zone of the reactor to create turbulences that help in the temperature regulation and kinetics. In another embodiment, the reactor can be equipped with several recirculation loops. A fraction of the fluid is also directed towards the reactor outlet to the collection tanks. Picture 1 provides for a schematic representation of the reactor set up. In a preferred embodiment, part of the liquid is recycled from the top of the reactor to the bottom of the reactor. Picture 2 shows a reinjection bottom. In one embodiment, the length of the reactor column is about 70 cm and diameter is about 100 mm. The skilled person will know how to adjust the dimensions to achieve the desired capacity for the equipment. The residence time can be adapted to the specific desired reaction by adjusting flow parameters such as fluid injection rate and recirculation rate.

In an embodiment, the part of liquid recirculated is equal to 20% up to 100% of the part directed towards the reactor outlet. In a preferred embodiment, the part of liquid recirculated is equal to or up to most preferably 1 to 15 times larger than the part directed towards the reactor outlet.

In an embodiment, the part of liquid recirculated is equal to or up to most preferably 1 to 30 times larger than the part directed towards the reactor outlet. In an embodiment, the part of liquid recirculated is 1 to 30 times larger than the part directed towards the reactor outlet. In an embodiment, the part of liquid recirculated is 1 to 15 times larger than the part directed towards the reactor outlet. In an embodiment, the part of liquid recirculated is 15 to 30 times larger than the part directed towards the reactor outlet. In an embodiment, the part of liquid recirculated is 10 to 20 times larger than the part directed towards the reactor outlet.

In an embodiment, the top of the reactor is also where the liquid level is measured, where nitrogen is injected in the reactor to maintain the reactor pressure while maintaining an inert atmosphere for the process, and where metal is injected into the reactor. This part supports the reliable operation of the process.

In an embodiment, the reactor is pressurized, preferably to 0.01-10 barg, more preferably to 2-4 barg. In an embodiment, the reactor is pressurized, preferably to 2-10 barg, more preferably to about 3 barg. The reaction is occurring in a pressurized equipment, allowing to reach temperatures above the boiling point of the substrate or mixture of substrate and solvents under normal pressure and temperature conditions. The higher temperatures will positively affect the kinetics of the chemical reaction improving the conversion rate and reducing the required residence time.

In an embodiment, the solid metal particulates range in size from 1 μm to 10 mm when added. In an embodiment, the solid metal particulates range in size from 100 μm to 10 mm when added, preferably 500 μm to 5 mm. Preferably, the diameter ranges from 100 μm to 7 mm, more preferably from 500 μm to 5 mm. In an embodiment, the solid metal particulates range in size from 1.1 to 3.0 mm.

In an embodiment, the solid metal particulates range in size from 100 μm to 5 mm. In an embodiment, the solid metal particulates range in size from 100 μm to 300 μm. In an embodiment, the solid metal particulates range in size from 1 mm to 3 mm.

In an embodiment, the metal in the metal bed comprises a metal, preferably magnesium, zinc or lithium. In an embodiment, the metal is an alkali metal, preferably lithium, an alkaline earth metal preferably magnesium, an earth metal, preferably aluminum, a transition metal, preferably zinc or any other metal.

In an embodiment, metal particulates are fed such that a molar excess of the metal particulates is present in the reactor relative to the substrate, preferably an organohalide. In a further embodiment, the molar excess is at least 5-times molar excess, preferably 20 to 80 times.

In an embodiment, the solvent is selected from saturated hydrocarbons, aromatic hydrocarbons, ethers, polyethers, tertiary amines, other aprotic solvents, or mixtures of one or more of the above. In a further embodiment, the water-free solvent comprises an ether, preferably cyclopentyl methyl ether (CPME), tetrahydrofuran, dioxane, dimethoxyethane, diethyl ether, 2-methyl-tetrahydrofuran, 4-methyltetrahydropyran (4-MeTHP), methyl-tert-butylether (MTBE), mixtures thereof or mixtures thereof with other aprotic organic solvents, in particular toluene. In another embodiment, the substrate is contacted on the metal bed without the use of a solvent.

In an embodiment, the temperature of the substrate entering the reactor is modified to optimize the production of at least one organometallic compound. In an embodiment, a heat exchanger is used for modifying the temperature of the substrate before entering the reactor. In an embodiment, the temperature of the substrate entering the reactor and the power of the heat exchanger are modified to optimize the production of at least one organometallic compound.

In one embodiment the volume of the reactor can be varied to the capacity requirements of the installation. The thermal management of the reaction being insured through the recirculation loop, possibly equipped with heat exchangers, the scaleability of the reactor is not limited by the surface to volume ratio. Reactors set up with reactor volume from 0.2 l to 24 l, with throughput capacity from 0.1 to 30 l/h have been operated with identical reaction conditions. No limitation for further scale up has been identified. In one embodiment, the thermal management of the reaction is insured through a combination of a recirculation loop as described above and a double jacketed column containing a refrigerating fluid. In one embodiment, the inner diameter of the column is about 3 cm to 8 cm, or from about 10 cm to about 35 cm.

In an embodiment, the substrate (R) is selected from (i) a substituted or unsubstituted linear, branched or cyclic alkyl group having from 1 to 20 carbon atoms, (ii) a substituted or unsubstituted allyl, alkenyl, alkynyl, allyl, aryl and heteroaryl groups.

The process of the present invention achieves high conversion and high yield of the organometallic compound, regardless of the size of the reactor and throughput. Table II gives an overview of some of the compounds tested and their conversion rate.

TABLE II
Reaction conditions for the provided examples.

| | | | | | | | Conver- |
|---|---|---|---|---|---|---|---|
| | | | | Temp. | Flow rate | Conc. | sion |
| # | Substrate | Metal | Solvent | (° C.) | (g/h) | (% wt.) | (%) |
| 1 | Vinyl | Mg | THF | 30-50 | 60-300 | 14 | ND |
| | bromide | | | | | | |
| 2 | Cyclopentyl | Mg | THF | 50 | 120-240 | 10 | >99 |
| | bromide | | | | | | |
| 3 | n-pentyl | Mg | THF | 50 | 120 | 33 | 95 |
| | chloride | | | | | | |
| 4 | i-propyl | Mg | THF | 30-60 | 5400-9000 | 20 | >99 |
| | chloride | | | | | | |
| 5 | n-butyl | Mg | THF | 55-65 | 1600-2700 | 24 | >99 |
| | chloride | | | | | | |
| 6 | n-pentyl | Mg | Et2O | 45-65 | 120-180 | 37 | 97 -> 99 |
| | bromide | | | | | | |
| 7 | Cyclohexyl | Mg | THF: | 85 | 120-300 | 20 | 92-96 |
| | chloride | | PhMe | | | | |
| 8 | ethyl 2- | Zn | THF | 80 | 60-600 | 13 | >99 |
| | bromoacetate | | | | | | |

In another embodiment, the metal particulates have a natural oxide layer formed on their surface. Activation of metal particulates is then undertaken by removing the oxide layer with 1,2-dibromoethane, iodine etching, diisobutylaluminum hydride, any organohalide, preferably an organobromide or an organoiodide, or preferably by pre-flushing the particulates with pre-produced organometallic compound. In a preferred embodiment, the reactor with magnesium particulates is heated in presence of an existing Grignard reagent. In another embodiment, the reactor with magnesium particulates is filled with existing Grignard reagent at room temperature without heating.

In a preferred way of operating, the present invention provides a continuous process comprising contacting metal particulates with a substrate in a reactor, forming an organometallic intermediate continuously, and reacting such intermediate with another substrate.

Organometallic compounds are most often highly air and moisture sensitive. They can also be pyrophric. They are therefore difficult to store and to handle safely. In one embodiment of the present invention, the organometallic compound, once formed is consumed in-situ in a subsequent reactor, for example a flow reactor, in presence of another substrates, as defined above, to obtain the desired product.

In another embodiment, the first and the second substrates, as defined above, can be mixed and circulated as a mixture through the metal bed, resulting in the organometallic reagent formation and its subsequent reaction with the second substrates taking place in a single step.

In a second aspect, the invention relates to a device for the production of at least one organometallic compound comprising: an element for the addition of solid metallic particulates; a reactor column comprising: an injection bottom, a reactor head with outlet; and a recirculation loop.

In an embodiment, the reactor head comprises a settling zone with a cross section surface at least 100% bigger compared to the cross section surface of the reactor column. In an embodiment, the recirculation loop is equipped with a heat exchanger and a recirculation pump.

In an embodiment, the reactor head comprises a settling zone with a cross section surface at least 200% bigger compared to the cross section surface of the reactor column, preferably 300% bigger.

In an embodiment, the ratio of the height of the settling zone over the total height of the reactor is between 1:2 and 1:10, preferably 1:5 to 1:9.

In an embodiment, the organometallic compound is a Grignard Reagent.

In one embodiment, a feeder of fresh metal particulates continuously replenishes the reactor to compensate for the metal consumed by the reaction. In another embodiment, a grinder device is attached to a cutting chamber, which in turn may be attached to the reactor column. In an embodiment, the solid metal particulates are added to the reactor by two gas tight valves flushed with an inert gas, preferably nitrogen. Said valves are isolating a chamber from the reactor, called the Lock. The inventors have observed that said method provides a reliable metal supply to the pressurized reactor without contaminating the reactor with oxygen or water.

In an embodiment, the device further comprises: at least one metal feeding system, a rector column equipped with a recirculation loop, inlets, outlets, measuring device, pumps, valves, control systems.

In an embodiment, the injection bottom is designed to allow the even distribution of the fluids on the section of the reactor ensuring an homogeneous distribution of the fluids from the bottom and reducing the occurrence of channeling into the reactor embodiment (FIG. 2). In a further embodiment, the fluid circulates through the metal bed at a vertical speed of 3 mm/s to 30 mm/s.

In an embodiment, the fluid circulates through the metal bed at a vertical speed of 25 mm/s to 50 mm/s. In an embodiment, the fluid circulates through the metal bed at a vertical speed of 3 mm/s to 30 mm/s. In an embodiment, the fluid circulates through the metal bed at a vertical speed of 3 mm/s to 10 mm/s. In an embodiment, the fluid circulates through the metal bed at a vertical speed of 10 mm/s to 20 mm/s. In an embodiment, the fluid circulates through the metal bed at a vertical speed of 20 mm/s to 30 mm/s. In an embodiment, the fluid circulates through the metal bed at a vertical speed of 3 mm/s to 50 mm/s.

In one embodiment, the reactor column is made from glass, metal (such as for example steel or stainless steel), or contain polymeric material (such as Teflon), or a combination thereof. Preferably, the reactor column is a stainless steel column, preferably ASME-BPE pharmaceutical grade 316L Stainless steel.

In another aspect, the invention relates to compounds produced according to the first aspect or with the second aspect. Said compounds are organometallic compounds. The invention also relates to the organic compounds produced from such organometallic compounds when used as chemical intermediates.

The present invention also provides for downstream industrial scale processes that rely on a recirculation loop continuous process for preparing organometallic intermediates. In an embodiment, organometallic intermediates used as raw materials for production of active pharmaceuticals are prepared under this process for reaction with a substrate. In another embodiment, the present process is integrated as part of a larger process to prepare fragrance chemicals, agrochemicals or other industrial chemicals.

In another aspect, the invention relates to a chemical substance produced from the compound according to the previous aspect.

The invention is further described by the following non-limiting examples which further illustrate the invention, and are not intended to, nor should they be interpreted to, limit the scope of the invention.

The present invention will be now described in more details, referring to examples that are not limitative.

### EXAMPLES

### Example 1: Synthesis of vinylMgBr (14% wt. in THF)

### From an Uninitiated Reactor:

The pressurized reactor is filled with magnesium particulates and tetrahydrofuran under an inert atmosphere. The recirculation pump is then switched on with a flow rate of 6-18 l/hour in the reactor and the reaction mixture is heated to 20-60° C. using the heat exchanger. A solution of vinyl bromide (11.5% wt. in THF) is then injected at 60-300 g/hour until an exotherm is measured by the temperature probes. The reaction mixture's temperature is then lowered to 30-50° C. while the recirculation flow rate is set at 4-7 l/hour. The product's quality is continuously monitored via an online analytical monitoring tool before collection under inert atmosphere. During the production process, tetrahydrofuran, vinyl bromide and magnesium particulates are continuously supplied in the reactor at constant rates. The process was operated for several hours without interruption.

### From a Paused Pre-Initiated Reactor:

The pressurized reactor, filled with magnesium particulates and vinylmagnesium bromide (10% wt. in tetrahydrofuran), is heated to its setpoint temperature, i.e. 5-20° C., while the recirculation pump is switched on with a flow rate of 5-7 l/hour. A solution of vinyl bromide (11.5% wt. in THF) is then injected at 360-480 g/hour. The product's quality is continuously monitored via an online analytical monitoring tool before collection under inert atmosphere. During the production process, tetrahydrofuran, vinyl bromide and magnesium particulates are continuously supplied in the reactor at constant rates.

### Example 2: Synthesis of cyclopentylMgBr (10% wt. in THF)

### From a Paused Pre-Initiated Reactor:

The pressurized reactor, filled with magnesium particulates and cyclopentylmagnesium bromide (10% wt. in tetrahydrofuran), is heated to its setpoint temperature, i.e. 50° C., while the recirculation pump is switched on with a flow rate of 7 l/hour. A solution of cyclopentyl bromide (8.7% wt. in THF) is then injected at 120-240 g/hour. The product's quality is continuously monitored via an online analytical monitoring tool before collection under inert atmosphere. During the production process, tetrahydrofuran, cyclopentyl bromide and magnesium particulates are continuously supplied in the reactor at constant rates. During the steady state production stage of the reactor, 75 grams of Grignard solution were collected with an average concentration of 9.2% wt.

### Example 3: Synthesis of n-amylMgCl (33% wt. in THF)

### From an Uninitiated Reactor:

The pressurized reactor is filled with magnesium particulates and tetrahydrofuran under an inert atmosphere. The recirculation pump is then switched on with a flow rate of 5-7 l/hour in the reactor and the reaction mixture is heated to 50° C. using the heat exchanger. A solution of n-pentylchloride (28.7% wt. in THF) is then injected at 120 g/hour until an exotherm is measured by the temperature probes. The reaction mixture's temperature is kept at 50° C. while the recirculation flow rate is set at 7-8 l/hour. The product's quality is continuously monitored via an online analytical monitoring tool before collection under inert atmosphere. During the production process, tetrahydrofuran, n-pentylchloride and magnesium particulates are continuously supplied in the reactor at constant rates. During the steady state production stage of the reactor, 72 grams of Grignard solution were collected with an average concentration of 29.7% wt.

### Example 4: Synthesis of iPrMgCl (20% wt. in THF)

### a) From an Uninitiated Reactor:

The pressurized reactor is filled with magnesium particulates and tetrahydrofuran under an inert atmosphere. The recirculation pump is then switched on to its minimal flow rate and the reaction mixture is heated to 30-40° C. using the heat exchanger. A 1.0 molar solution of iso-propylchloride in THF is then injected at a flow rate of 20 L/hour in the reactor until an exotherm is measured by the temperature probes. The concentration of the injection mixture is then gradually increased to 1.9 molar while the heat exchanger setpoint is set at (T5+T1)/2 and the recirculation ratio, i.e. mass flow rate recirculation loop/mass flow rate injection, is set between 15 and 20. The product's quality is continuously monitored via an online analytical monitoring tool before collection under inert atmosphere. During the production process, tetrahydrofuran, iso-propylchloride and magnesium particulates are continuously supplied in the reactor at constant rates. The process mass balance is 99.9%.

### b) From a Paused Initiated Reactor:

The pressurized reactor filled with magnesium particulates and iso-propylmagnesium chloride (20% wt. in tetrahydrofuran) is heated to its setpoint temperature, i.e. 47° C., while the recirculation pump is started. When the reaction mixture reaches 35° C., the flow of iso-propyl chloride (1.9 M in tetrahydrofuran) is restarted. Under continuous process conditions, the recirculation ratio, i.e. mass flow rate recirculation loop/mass flow rate injection, ranges between 15 and 20. The product's quality is continuously monitored via an online analytical monitoring tool before collection under inert atmosphere. During the production process, tetrahydrofuran, iso-propylchloride and magnesium particulates are continuously supplied in the reactor at constant rates.

During the steady state production stage of the reactor, 573 kilograms of Grignard solution were collected with concentration ranging from 19.4 and 20.4% wt. The process mass balance is 99.9%.

### Example 5: Synthesis of n-BuMgCl (24% wt. in THF)

### From an Pre-Initiated Reactor:

The pressurized reactor is filled with preactivated magnesium particulates and tetrahydrofuran under an inert atmosphere. The recirculation pump is then switched on with an flow rate of 75 l/hour in the reactor and the reaction mixture is heated to 55-65° C. using the heat exchanger. A solution of n-butylchloride (8-10% wt. in THF) is then injected at 1.8-3.0 l/hour until an exotherm is measured by the temperature probes. The concentration of injected n-butylchloride is increased to 19-21% wt. and the recirculation ratio, i.e. mass flow rate_{recirculation loop}/mass flow rate_{injection}, is maintained between 25 and 42. The product's quality is continuously monitored via an online analytical monitoring tool before collection under inert atmosphere. During the production process, tetrahydrofuran, n-butylchloride and magnesium particulates are continuously supplied in the reactor at constant rates.

During the steady state production stage of the reactor, 43 kilograms of Grignard solution were collected with an average concentration of 23.4% wt. The process mass balance is 99.9%.

### Example 6: Synthesis of n-Amylmagnesium Bromide (37% wt. in Et₂O)

### From an Uninitiated Reactor:

The pressurized reactor is filled with magnesium particulates and diethyl ether under an inert atmosphere. The recirculation pump is then switched on with a flow rate of 0-12 l/hour in the reactor and the reaction mixture is heated to 45° C. using the heat exchanger. A solution of n-pentyl bromide (33.6% wt. in Et₂O) is then injected at 120-180 g/hour until an exotherm is measured by the temperature probes. The reaction mixture's temperature is then increased to 65° C. while the recirculation flow rate is set at 8-15 l/hour. The product's quality is continuously monitored via an online analytical monitoring tool before collection under inert atmosphere. During the production process, diethyl ether, n-pentyl bromide and magnesium particulates are continuously supplied in the reactor at constant rates. During the steady state production stage of the reactor, 84 grams of Grignard solution were collected with an average concentration of 37.4% wt.

### Example 7: Synthesis of Cyclohexylmagnesium Chloride (20% Wt. In THF/Toluene)

### From an Uninitiated Reactor:

The pressurized reactor is filled with magnesium particulates and tetrahydrofuran/toluene (50% weight ratio) under an inert atmosphere. The recirculation pump is then switched on with a flow rate of 5-13 l/hour in the reactor and the reaction mixture is heated to 85° C. using the heat exchanger. A solution of cyclohexylchloride (17.2% wt. in THF/toluene) is then injected at 120 g/hour until an exotherm is measured by the temperature probes. The reaction mixture's temperature is then kept at 85° C. while the recirculation flow rate is set maintained at 7-13 l/hour and the cyclohexyl chloride solution is injected at 120-300 g/hour. The product's quality is continuously monitored via an online analytical monitoring tool before collection under inert atmosphere. During the production process, tetrahydrofuran, toluene, cyclohexyl chloride and magnesium particulates are continuously supplied in the reactor at constant rates. During the steady state production stage of the reactor, 569 grams of Grignard solution were collected with an average concentration of 18.3% wt.

### Example 8: Synthesis of (2-Ethoxy-2-Oxo-Ethyl) Zinc Bromide (13% Wt. In THF)

### From an Uninitiated Reactor:

The pressurized reactor is filled with zinc particulates and (2-ethoxy-2-oxo-ethyl) zinc bromide (approximately 6% wt. in THF) under an inert atmosphere. The recirculation pump is not switched on and the reaction mixture is heated to 80-90° C. using the heat exchanger. A solution of ethyl bromoacetate (9.7% wt. in THF) is then injected at 60-120 g/hour until an exotherm is measured by the temperature probes. The reaction mixture's temperature is then maintained at 80° C. while the recirculation flow rate is regulated at 2-10 l/hour and the ethyl bromoacetate solution is injected at 60-600 g/hour. The product's quality is continuously monitored via an online analytical monitoring tool before collection under inert atmosphere. During the production process, tetrahydrofuran, ethyl bromoacetate and zinc particulates are continuously supplied in the reactor at constant rates. During the steady state production stage of the reactor, 66 grams of Grignard solution were collected with an average concentration of 7.2% wt.

### DESCRIPTION OF FIGURES

The present invention will now be further exemplified with reference to the following examples. It is clear that the method according to the invention, and its applications, are not limited to the presented examples.

The present invention is in no way limited to the embodiments described in the examples and/or shown in the figures. On the contrary, methods according to the present invention may be realized in many different ways without departing from the scope of the invention.

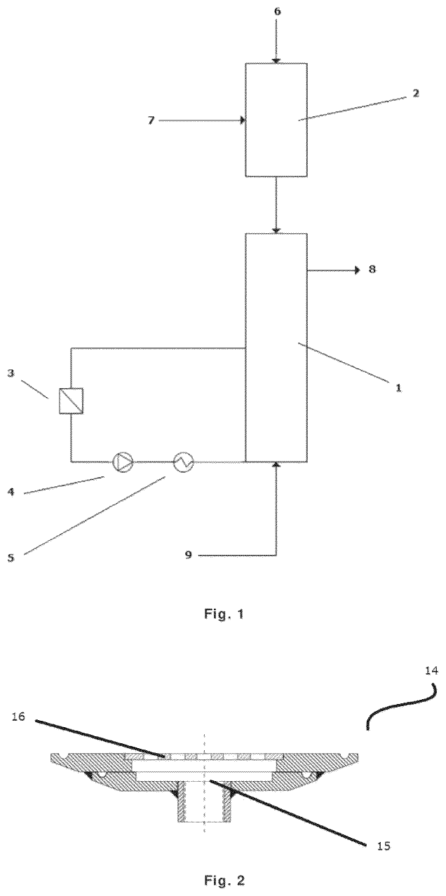

FIG. 1 shows a schematic representation of an embodiment of the present invention. Metal particulates are introduced in the reactor (1) via the Lock (2). The Lock is a chamber isolated from the reactor by two gas tight valves and is flushed with Nitrogen to ensure an inert atmosphere surrounding the metal prior to its insertion in the reactor (1). The recirculation loop allows for the thermic regulation of the fluid sent back into the reactor (1). It is composed of one automatic cleaning filter element (3) protecting a centrifugal pump (4) and one heat exchanger (5). The metal inlet (6), nitrogen inlet (7), RMX outlet (8), solvent and RX inlet (9) are indicated with arrows on the figure.

FIG. 2 shows an injection bottom (14) according to an embodiment of the present invention. The inlet, on the bottom of the reactor, is designed to allow the even distribution of the liquids entering the reactor and the injection of the liquids from the bottom of the flange (15) via a threaded insert. The bottom gasket fitted between the injection bottom and the bottom of the reactor is a screen gasket (16). A piece of wire mesh screen is moulded in the gasket. This allows the homogeneous distribution of the liquids on the section of the reactor while preventing magnesium particles to leave the reactor from the bottom.

### LIST OF NUMBERED ITEMS

1 reactor
2 Lock
3 filter element
4 centrifugal pump
5 heat exchanger
6 Metal Inlet
7 Nitrogen inlet
8 Outlet RMX
9 Inlet solvent and RX

1. A method for the production of at least one organometallic compound comprising: filling solid metal particulates or metal containing solid particulates into a reactor column obtaining a metal bed; continuously contacting a fluid of at least one substrate, preferably the fluid comprises a water-free solvent, with the metal bed; transporting the fluid against gravity through the metal bed, characterized in that, the fluid is partially recirculated again through a heat exchanger and over the metal bed at a recirculation ratio, wherein the recirculation ratio is the ratio between the mass flow rate through the metal bed and the mass flow rate of substrate entering the reactor and wherein the recirculation ratio is used to optimize the production of at least one organometallic compound.

2. Method according to claim 1, wherein the recirculation ratio is between 1:1 and 70:1.

3. Method according to claim 1 or 2, wherein the reactor column includes a settling zone with a cross section surface at least 100% bigger compared to the cross section surface of the reactor column.

4. Method according to any of the previous claims 1 to 3, wherein the solid metal particulates are added to the reactor by two gas tight valves flushed with an inert gas, preferably nitrogen.

5. Method according to any of the previous claims 1 to 4, wherein the solid metal particulates range in size from 100 μm to 10 mm when added, preferably 500 μm to 5 mm.

6. Method according to any of the previous claims 1 to 5, wherein the temperature of the substrate entering the reactor is modified to optimize the production of at least one organometallic compound.

7. Method according to any of the previous claims 1 to 6, wherein the reactor is pressurized, preferably to 0.01-10 barg, more preferably to 2-4 barg.

8. Method according to any of the previous claims 1 to 7, wherein metal particulates are fed such that a molar excess of the metal particulates is present in the reactor relative to the substrate, preferably the substrate is an organohalide.

9. Method according to any of the previous claims 1 to 8, wherein the fluid circulates through the metal bed at a vertical speed of 3 mm/s to 50 mm/s, preferably 25 mm/s to 50 mm/s.

10. Device for the production of at least one organometallic compound comprising: an element for the addition of solid metallic particulates; a reactor column comprising: an injection bottom, a reactor head with outlet; and a recirculation loop.

11. Device according to claim 10, wherein the reactor head comprises a settling zone with a cross section surface at least 100% bigger compared to the cross section surface of the reactor column.

12. Device according to claim 10 or 11, wherein the recirculation loop is equipped with a heat exchanger and a recirculation pump.

13. A compound produced according to the method described in any of the claims 1-9.

14. A compound produced with the device described in any of the claims 10-12.

15. A chemical substance produced from the compound according to claim 13 or 14.
